(19) United States
(12) Patent Application Publication
(10) Pub. No.: US 2008/0228676 A1
(43) Pub. Date: Sep. 18, 2008

(54) Computing device, method of controlling the computing device, and computer readable medium recording a program

(75) Inventors: Takashi Isozaki, Kanagawa (JP); Noriji Kato, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD, TOKYO (JP)

(21) Appl. No.: 11/907,365

(22) Filed: Oct. 11, 2007

(30) Foreign Application Priority Data
Mar. 15, 2007 (JP) 2007-066458

(51) Int. Cl. G06F 15/18

(52) U.S. Cl. 706/12

(57) ABSTRACT

A computing device stores a Bayesian network (20) which includes nodes (22) representing random variables and conditional probability indicating a dependence between the nodes, and at least one learned data table (30) in which a value of a random variable represented by the node included in the Bayesian network (20) is associated with a value of learned data inputted to the Bayesian network (20) concerning at least one of the nodes included in the Bayesian network; updates the learned data table (30); acquires the learned data inputted to the Bayesian network (20); and calculates a certainty factor of a value of a random variable represented by a node having a dependence with the node representing the random variable associated with the value of the learned data acquired by an acquisition section, at least based on the value of the random variable associated with the value of the learned data.

### CROSS-REFERENCE TO RELATED APPLICATIONS

This application is based on and claims priority under 35 USC 119 from Japanese Patent Application No. 2007-066458 filed Mar. 15, 2007.

### BACKGROUND

1. Technical Field

The present invention relates to a computing device, a method of controlling the computing device, and a computer readable medium for recording a program.

2. Related Art

In general, in computing devices in which a model of a Bayesian network is implemented, each time learned data inputted to the Bayesian network is learned, conditional probability and the like included in the Bayesian network are updated to further improve the precision of the model of the Bayesian network. In general, since the conditional probability and the like included in the Bayesian network are updated based on all the learned data that has been accumulated so far, as more learned data is accumulated, the learned data which is newly learned has a relatively small effect on the model. For this reason, when a change occurs in the tendency of the values of the learned data, it may be difficult to adjust the model to a changed situation.

### SUMMARY

According to an aspect of the present invention, there is provided a computing device including: a storage section that stores a Bayesian network which includes nodes representing random variables and conditional probability indicating a dependence between the nodes, and at least one learned data table in which a value of a random variable represented by the node included in the Bayesian network is associated with a value of learned data inputted to the Bayesian network concerning at least one of the nodes included in the Bayesian network; an acquisition section that acquires the learned data inputted to the Bayesian network; and a certainty factor calculation section that calculates a certainty factor of a value of a random variable represented by a node having a dependence with the node representing the random variable associated with the value of the learned data acquired by the acquisition section, at least based on the value of the random variable associated with the value of the learned data.

### BRIEF DESCRIPTION OF THE DRAWINGS

An exemplary embodiment of the present invention will be described in detail based on the following figures, wherein:

FIG. 1 is a functional block diagram of a computing device according to the exemplary embodiment of the present invention;

FIG. 2 is a schematic diagram showing an example of a Bayesian network according to the exemplary embodiment of the present invention;

FIG. 3 is a schematic diagram showing an example of the Bayesian network according to the exemplary embodiment of the present invention;

FIGS. 4A and 4B show example conditional probability tables that express the Bayesian network according to the exemplary embodiment of the present invention;

FIG. 5 is a diagram showing a specific example of the Bayesian network according to the exemplary embodiment of the present invention;

FIG. 6 is a flowchart of processing performed by a control device;

FIG. 7 is a diagram showing a specific example of the Bayesian network according to the exemplary embodiment of the present invention; and

FIG. 8 is a diagram showing a specific example of the Bayesian network according to the exemplary embodiment of the present invention.

### DETAILED DESCRIPTION

A computing device according to an exemplary embodiment of the present invention is configured, for example, by a known personal computer that includes a control device such as a CPU, a storage device such as a RAM and a hard disk, an output device such as a display, an input device such as a keyboard, and a communication device such as a network board.

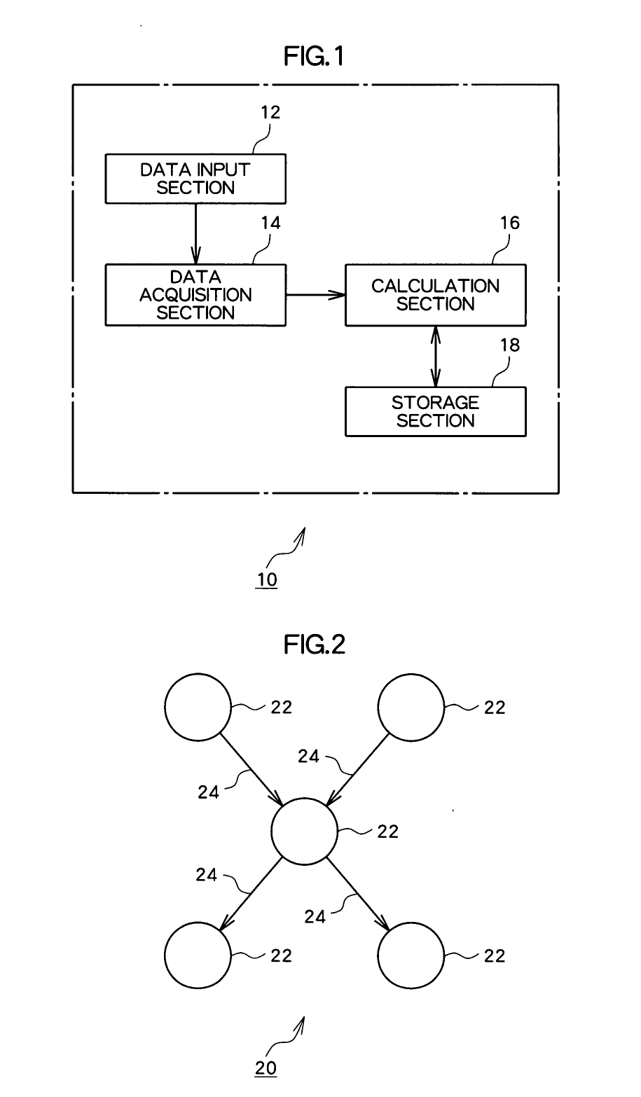

FIG. 1 is a functional block diagram showing a relationship among respective functions realized by the computing device 10. As shown in FIG. 1, the computing device 10 includes, as functional components, a data input section 12, a data acquisition section 14, a calculation section 16, and a storage section 18.

The data input section 12 is realized by the input device such as a keyboard. The data acquisition section 14 and the calculation section 16 are realized when the control device such as a CPU included in the computing device 10 executes a calculation program installed in the computing device 10. The calculation program is supplied to the computing device 10 by an information transfer medium such as a CD-ROM and a DVD-ROM or via a communication network such as the Internet. The storage section 18 is realized by the storage device such as a RAM and a hard disk.

The storage section 18 stores a Bayesian network. The Bayesian network includes nodes that represent random variables indicating uncertain events, a link that indicates a qualitative dependence between the nodes, and conditional probability that indicates a quantitative relationship between the nodes.

FIG. 2 is a schematic diagram showing an example of a Bayesian network 20. The Bayesian network 20 of FIG. 2 includes five nodes 22. The nodes 22 are linked by directed links 24.

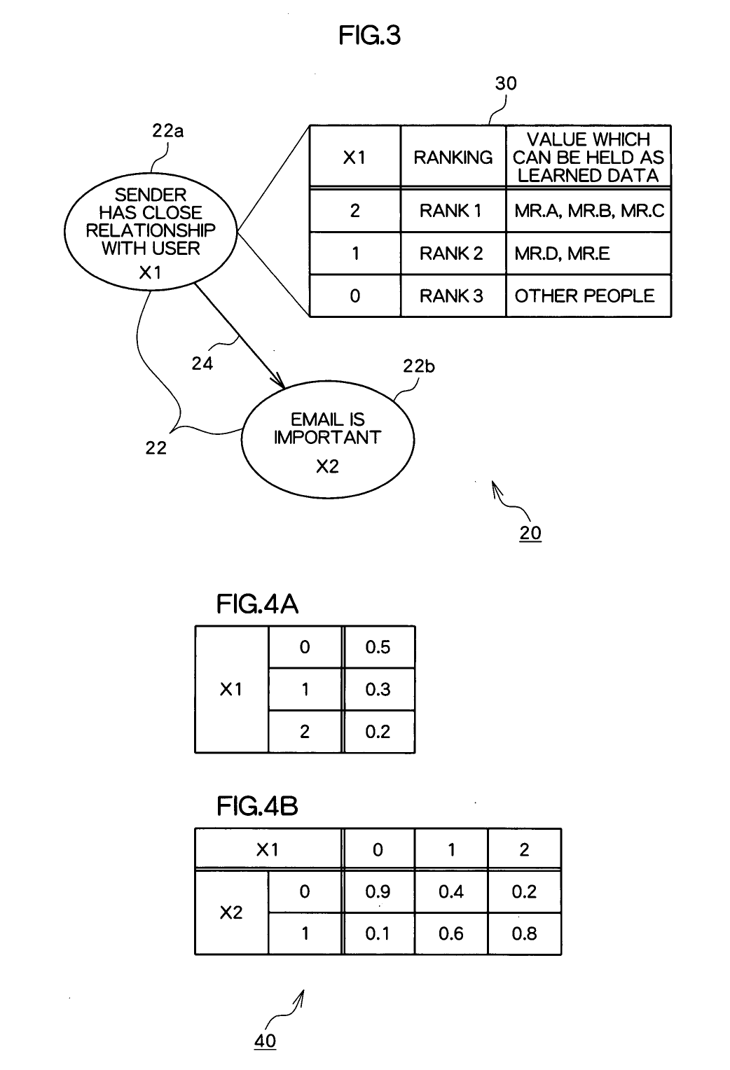

This exemplary embodiment shows an example case where the level of email importance is calculated while focusing on a cause node 22a (representing a random variable X1) and a result node 22b (representing a random variable X2) shown in FIG. 3 of the Bayesian network 20.

The cause node 22a represents the random variable X1 indicating an event that an email sender has a close relationship with the user. The random variable X1 can hold any of three values of 0, 1, and 2. For example, the value 2 indicates a person who has a close relationship with the user (Rank 1), the value 1 indicates a person who has a relationship with the user (Rank 2), and the value 0 indicates a person who has no relationship with the user (Rank 3). The result node 22b represents the random variable X2 indicating an event that the email is important. The random variable X2 can hold any of two values of 0 and 1. The value 1 indicates that the email is important, and the value 0 indicates that the email is not important.

The directed link 24 links the cause node 22a to the result node 22b in the direction from the cause node 22a to the result node 22b. It is sufficient that the event indicated by the random variable X1 and the event indicated by the random variable X2 have a qualitative dependence, but there is no need to have a causal relationship.

The cause node 22a of the Bayesian network 20 shown in FIG. 3 is associated with a learned data table 30. The learned data table 30 associates each of the values which can be held as the random variable X1 represented by the cause node 22a with a value (individual data) which can be held as learned data. In the example of the Bayesian network 20 shown in FIG. 3, individual data of people (Mr. A to Mr. E and other people) who can be senders of emails is associated with each rank of senders. The learned data table 30 shown in FIG. 3 is stored in the storage section 18.

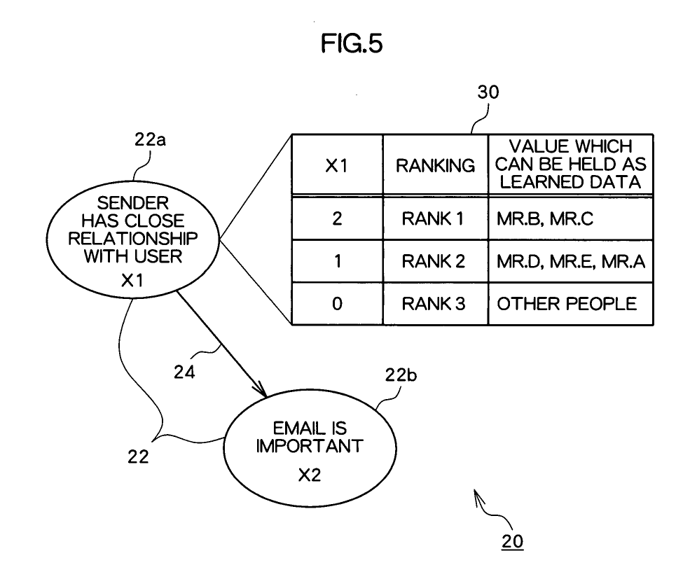

The Bayesian network 20 shown in FIG. 3 may express a quantitative relationship between the respective nodes 22 by using conditional probability tables 40a and 40b shown in FIGS. 4A and 4B. The conditional probability tables 40a and 40b are stored in the storage section 18.

An example case is shown in which a certainty factor of a value of the random variable X2 is calculated while the conditional probability tables 40a and 40b shown in FIGS. 4A and 4B are applied to the specific example of FIG. 3. Note that the certainty factor is a numeric value indicating the probability of judgment, and is expressed by a real number which falls in the range from 0 to 1 inclusive.

For example, when an email sender is Mr. A, it is found from the learned data table 30 shown in FIG. 3 that this email sender is associated with Rank 1, so the value of the random variable X1 is 2. In this case, from the conditional probability table 40b shown in FIG. 4B, the certainty factor in which the value of the random variable X2 is 1, in other words, the certainty factor in which the email is important, is calculated to be 0.8. Further, the certainty factor in which the value of the random variable X2 is 0, in other words, the certainty factor in which the email is not important, is calculated to be 0.2.

On the other hand, for example, when an email sender is a person other than Mr. A to Mr. E, it is found from the learned data table 30 shown in FIG. 3 that this email sender is associated with Rank 3, so the value of the random variable X1 is 0. In this case, from the conditional probability table 40b shown in FIG. 4B, the certainty factor in which the value of the random variable X2 is 1, in other words, the certainty factor in which the email is important, is calculated to be 0.1. Further, the certainty factor in which the value of the random variable X2 is 0, in other words, the certainty factor in which the email is not important, is calculated to be 0.9.

It is assumed that individual data indicating Mr. A is updated from Rank 1 to Rank 2 in the learned data table 30 as shown in FIG. 5. When email is sent from Mr. A after the learned data table 30 has been updated, the value of the random variable X1 is 1. In this case, from the conditional probability tables 40b shown in FIG. 4B, the certainty factor in which the value of the random variable X2 is 1, in other words, the certainty factor in which the email is important, is calculated to be 0.6. Further, the certainty factor in which the value of the random variable X2 is 0, in other words, the certainty factor in which the email is not important, is calculated to be 0.4.

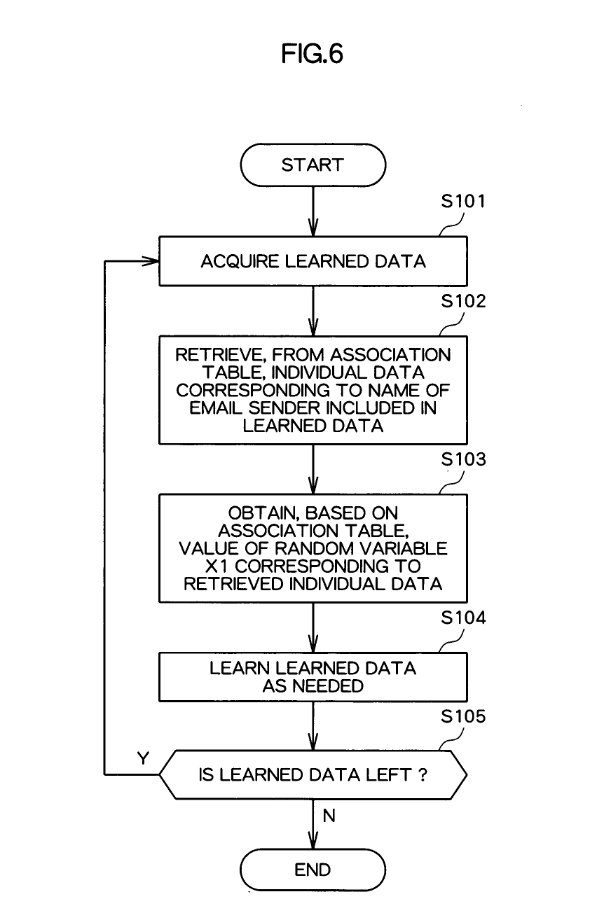

Next, a description is given of processing performed in the computing device 10 according to the exemplary embodiment of the present invention, with reference to the functional block diagram shown in FIG. 1 and a flowchart shown in FIG. 6.

The storage section 18 stores in advance the conditional probability tables 40a and 40b shown in FIGS. 4A and 4B. The storage section 18 also stores the learned data table 30 shown in FIG. 3.

The data acquisition section 14 acquires learned data through the data input section 12 (S101) In this exemplary embodiment, the learned data includes the name of an email sender. The calculation section 16 retrieves, from the learned data table 30, individual data corresponding to the name of an email sender included in the learned data (S102). The calculation section 16 obtains, from the learned data table 30, a value of the random variable X1 corresponding to the retrieved individual data (S103) The calculation section 16 learns the learned data as needed (S104). Specifically, the values of the conditional probability tables 40a and 40b, stored in the storage section 18, are updated. A series of these steps are repeated until no learned data is left (S105).

Hereinafter, modifications of this exemplary embodiment will be described.

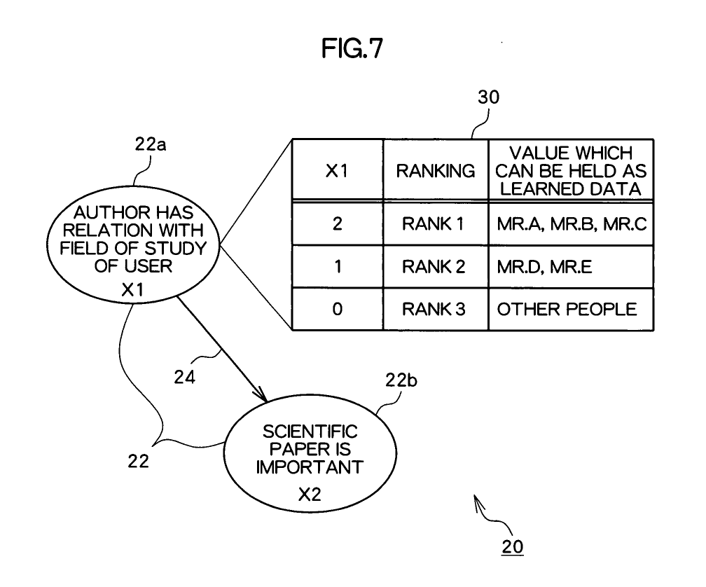

For example, the following application examples are conceivable. As shown in FIG. 7, the Bayesian network 20 includes the result node 22b (representing the random variable X2) indicating an event that a scientific paper is important, the cause node 22a (representing the random variable X1) indicating an event that the author has a relation with the area of study of the user, and the directed link 24 connecting the cause node 22a to the result node 22b. The cause node 22a is associated with the learned data table 30 in which a person who can be an author is associated with a rank indicating the degree of relation with the area of study of the user.

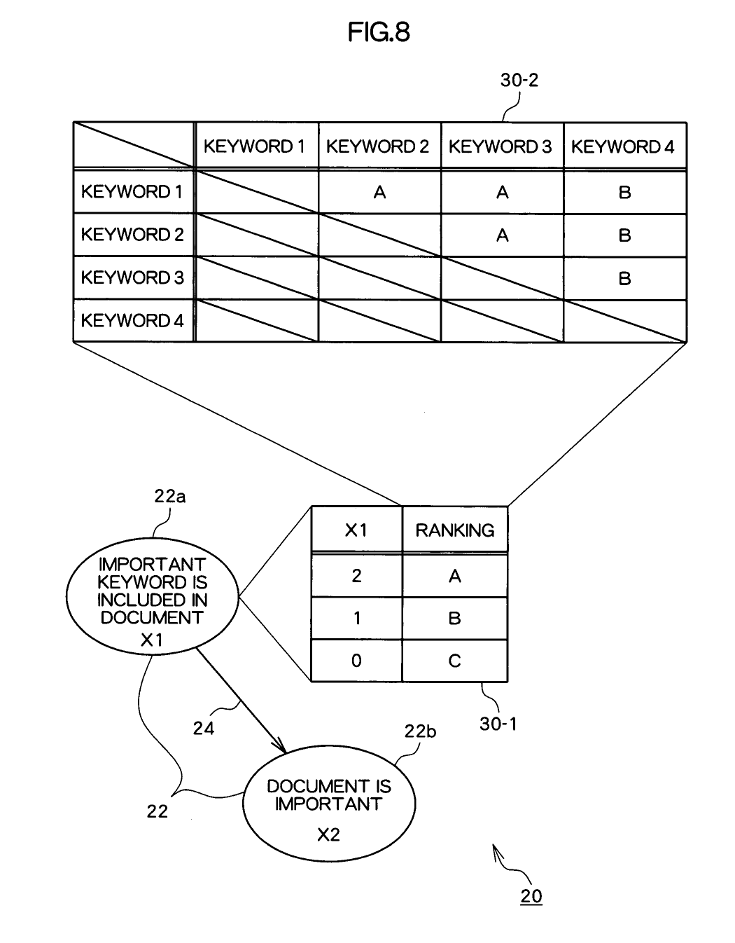

Further, as shown in FIG. 8, the Bayesian network 20 includes the result node 22b (representing the random variable X2) indicating an event that a document is important, the cause node 22a (representing the random variable X1) indicating an event that an important keyword is included in the document, and the directed link 24 connecting the cause node 22a to the result node 22b. The cause node 22a is associated with a first learned data table 30-1. In the first learned data table 30-1, each value which can be held as the random variable X1, represented by the cause node 22a, is associated with a keyword rank. Further, the keyword rank is associated with a second learned data table 30-2. The keyword rank is assigned to each keyword co-occurrence relation.

Note that the learned data table 30, shown in FIG. 3 and the like, does not necessarily indicate ranks.

Further, the single Bayesian network 20 may include multiple learned data tables 30 such as that shown in FIG. 3.

The data acquisition section 14 may acquire learned data stored in the storage section 18, instead of acquiring learned data through the data input section 12.

The present invention is not limited to the above-described exemplary embodiment. It is needless to say that the present invention can be widely applied to a system in which electronic documents are accumulated in a server, and when user authentication is performed in an information processor connected to the server via a network, and when an authenticated user is the user who owns the electronic documents or their agent, the electronic documents are sent to the information processor.

What is claimed is:

1. A computing device, comprising:
a storage section that stores a Bayesian network which includes nodes representing random variables and conditional probability indicating a dependence between the nodes, and at least one learned data table in which a value of a random variable represented by the node included in the Bayesian network is associated with a value of learned data inputted to the Bayesian network concerning at least one of the nodes included in the Bayesian network;
an acquisition section that acquires the learned data inputted to the Bayesian network; and
a certainty factor calculation section that calculates a certainty factor of a value of a random variable represented by a node having a dependence with the node representing the random variable associated with the value of the learned data acquired by the acquisition section, at least based on the value of the random variable associated with the value of the learned data.

2. The computing device according to claim 1, further comprising a learned data table updating section that updates an association between a value which can be held as the random variable and a value which can be held as the learned data, in the learned data table.

3. The computing device according to claim 1, wherein in the learned data table stored in the storage section, a value which can be held as the random variable represented by the node included in the Bayesian network is associated with a combination of values which can be held as the learned data inputted to the Bayesian network concerning at least one of the nodes included in the Bayesian network.

4. A method of controlling a computing device, comprising:
storing a Bayesian network which includes nodes representing random variables and conditional probability indicating a dependence between the nodes, and at least one learned data table in which a value of a random variable represented by the node included in the Bayesian network is associated with a value of learned data inputted to the Bayesian network concerning at least one of the nodes included in the Bayesian network;
acquiring the learned data inputted to the Bayesian network; and
calculating a certainty factor of a value of a random variable represented by a node having a dependence with the node representing the random variable associated with the value of the learned data acquired in the acquiring, at least based on the value of the random variable associated with the value of the learned data.

5. A program recording medium recording a program causing a computer to execute a process comprising:
storing a Bayesian network which includes nodes representing random variables and conditional probability indicating a dependence between the nodes, and at least one learned data table in which a value of a random variable represented by the node included in the Bayesian network is associated with a value of learned data inputted to the Bayesian network concerning at least one of the nodes included in the Bayesian network;
acquiring the learned data inputted to the Bayesian network; and
calculating a certainty factor of a value of a random variable represented by a node having a dependence with the node representing the random variable associated with the value of the learned data acquired in the acquiring, at least based on the value of the random variable associated with the value of the learned data.
